(19) United States
(12) Patent Application Publication
(10) Pub. No.: US 2002/0178631 A1
(43) Pub. Date: Dec. 5, 2002

(54) Medical information storage and display device

(76) Inventor: Robert Morton, Norristown, PA (US)

Correspondence Address: Richard W. Goldstein, 2071 Clove Road, Staten Island, NY, 10304, US

(21) Appl. No.: 09/872,022

(22) Filed: Jun. 1, 2001

(51) Int. Cl. G09F 3/14

(52) U.S. Cl. 40/665

(57) ABSTRACT

A medical information storage and display device including a housing having a front face, a back face, a top wall, a bottom wall, and opposed side walls. The housing has a programmable memory chip disposed interiorly thereof. The front face has a display disposed therein. The display is in communication with the programmable memory chip. The display includes a pair of programming buttons used to program a person's name, date of birth, medical condition, emergency contact and telephone number, and allergies.

### BACKGROUND OF THE INVENTION

The present invention relates to a medical information storage and display device and more particularly pertains to storing medical information of an individual for easy access in the event of an emergency.

The use of medical information systems is known in the prior art. More specifically, medical information systems heretofore devised and utilized for the purpose of storing medical information of individuals are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,086,391 to Chambers discloses a medical alert system capable of containing a library of information regarding the appropriate treatment for an individual. U.S. Pat. No. 4,335,377 to Bostic discloses a medical alert system capable of containing information concerning the nature of an individual's medical problems. U.S. Pat. No. 3,634,885 to Barkely discloses a medical alert system.

While these devices fulfill their respective, particular objective and requirements, the aforementioned patents do not describe a medical information storage and display device for storing medical information of an individual for easy access in the event of an emergency.

In this respect, the medical information storage and display device according to the present invention substantially departs from the conventional concepts and designs of the prior art, and in doing so provides an apparatus primarily developed for the purpose of storing medical information of an individual for easy access in the event of an emergency.

Therefore, it can be appreciated that there exists a continuing need for a new and improved medical information storage and display device which can be used for storing medical information of an individual for easy access in the event of an emergency. In this regard, the present invention substantially fulfills this need.

### SUMMARY OF THE INVENTION

In the view of the foregoing disadvantages inherent in the known types of medical information systems now present in the prior art, the present invention provides an improved medical information storage and display device. As such, the general purpose of the present invention, which will be described subsequently in greater detail, is to provide a new and improved medical information storage and display device which has all the advantages of the prior art and none of the disadvantages.

To attain this, the present invention essentially comprises a housing having a generally rectangular configuration The housing has a front face, a back face, a top wall, a bottom wall, and opposed side walls. The top wall has a pair of eyelets extending upwardly therefrom. The housing has a programmable memory chip disposed interiorly thereof. The front face has a display disposed therein. The display is in communication with the programmable memory chip. The display includes a pair of programming buttons used to program a person's name, date of birth, medical condition, emergency contact and telephone number, and allergies. A circular line extends through the pair of eyelets of the housing to allow the housing to be worn about a neck of a user.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved medical information storage and display device which has all the advantages of the prior art medical information systems and none of the disadvantages.

It is another object of the present invention to provide a new and improved medical information storage and display device which may be easily and efficiently manufactured and marketed.

It is a further object of the present invention to provide a new and improved medical information storage and display device which is of durable and reliable construction.

An even further object of the present invention is to provide a new and improved medical information storage and display device which is susceptible of a low cost of manufacture with regard to both materials and labor, and which accordingly is then susceptible of low prices of sale to the consuming public, thereby making such a medical information storage and display device economically available to the buying public.

Even still another object of the present invention is to provide a new and improved medical information storage and display device for storing medical information of an individual for easy access in the event of an emergency.

Lastly, it is an object of the present invention to provide a new and improved medical information storage and display device including a housing having a front face, a back face, a top wall, a bottom wall, and opposed side walls. The housing has a programmable memory chip disposed interiorly thereof. The front face has a display disposed therein. The display is in communication with the programmable memory chip. The display includes a pair of programming buttons used to program a person's name, date of birth, medical condition, emergency contact and telephone number, and allergies.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the medical information storage and display device constructed in accordance with the principles of the present invention.

FIG. 2 is a plan view of the display of the present invention.

FIG. 3 is a front view of the present invention illustrated in place on a wearer.

FIG. 4 is a schematic illustration of the present invention.

The same reference numerals refer to the same parts through the various figures.

### DESCRIPTION OF THE PREFERRED EMBODIMENT

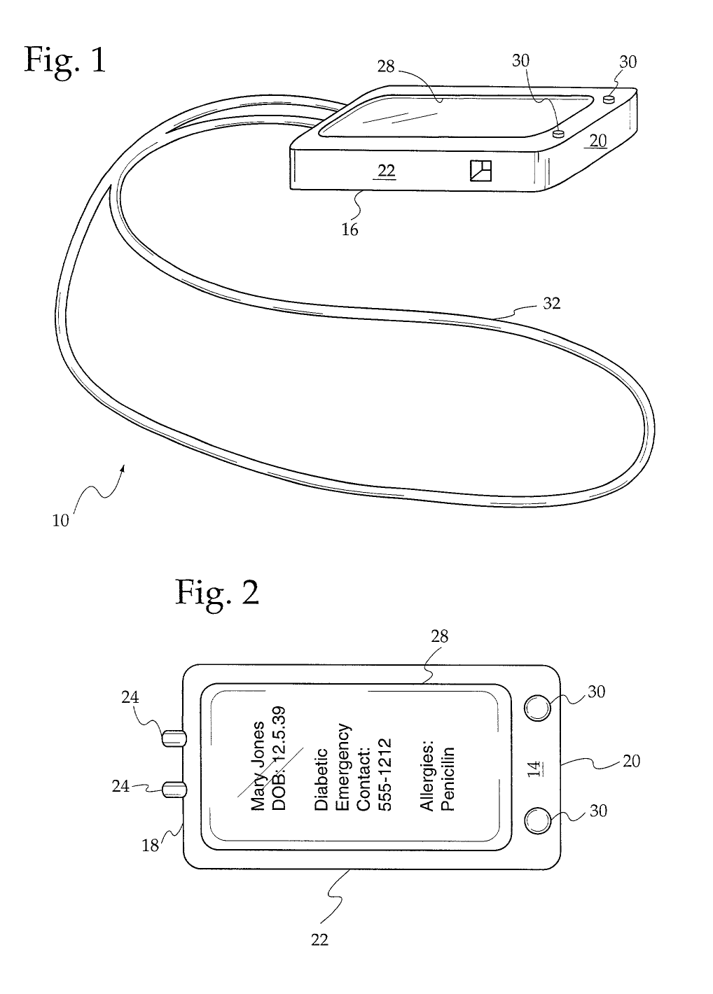

With reference now to the drawings, and in particular, to FIGS. 1 through 4 thereof, the preferred embodiment of the new and improved medical information storage and display device embodying the principles and concepts of the present invention and generally designated by the reference number 10 will be described.

Specifically, it will be noted in the various figures that the device relates to a medical information storage and display device for storing medical information of an individual for easy access in the event of an emergency. In its broadest context, the device consists of a housing and a circular line. Such components are individually configured and correlated with respect to each other so as to attain the desired objective.

The housing 12 has a generally rectangular configuration. The housing 12 has a front face 14, a back face 16, a top wall 18, a bottom wall 20, and opposed side walls 22. The top wall 18 has a pair of eyelets 24 extending upwardly therefrom. The housing 12 has a programmable memory chip 26 disposed interiorly thereof. The front face 14 has a display 28 disposed therein. The display 28 is in communication with the programmable memory chip 26. The display 28 includes a pair of programming buttons 30 used to program a person's name, date of birth, medical condition, emergency contact and telephone number, and allergies. Additionally, the memory chip 26 could also be interfaced with a computer 31 to provide additional information about a patient and their condition as well as to complete the initial setup of the stored information.

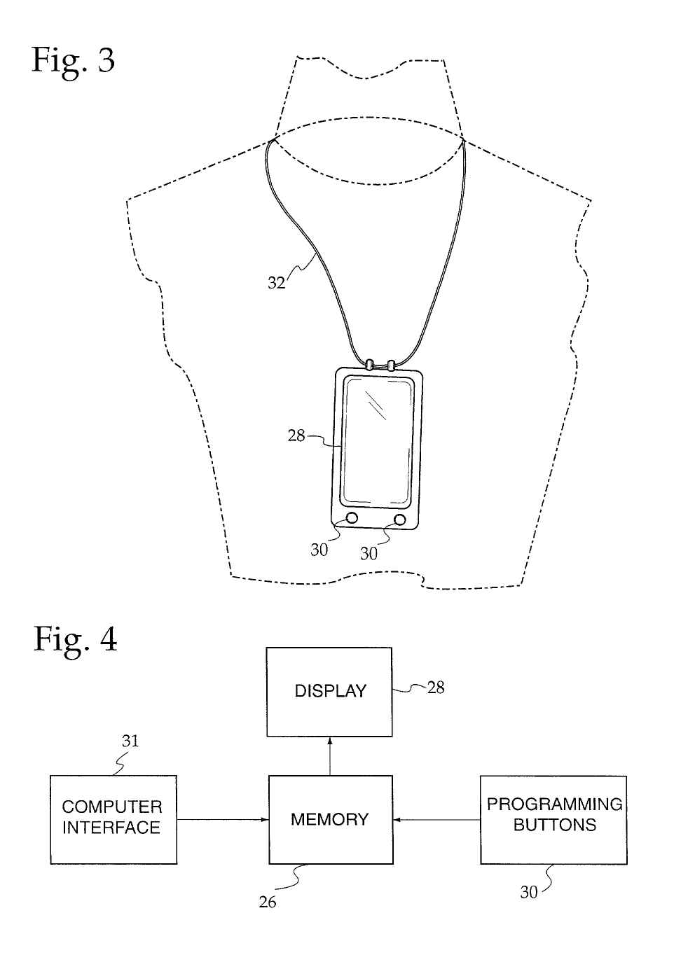

The circular line 32 extends through the pair of eyelets 24 of the housing 12 to allow the housing 12 to be worn about a neck of a user. Note FIG. 3. Alternately, the housing 12 could be adapted to worn in a manner akin to a bracelet.

The present invention will be programmed to include any relevant information that could aid doctors and other medical personnel in effectively treating a person that has been incapacitated. The doctor would simply press the programming buttons 30 to view the programmed information on the display 28. After assessing this information, the doctor can properly provide medical treatment to the patient without endangering the patient because of the knowledge of their medical history.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A medical information storage and display device for storing medical information of an individual for easy access in the event of an emergency comprising, in combination:
a housing having a generally rectangular configuration, the housing having a front face, a back face, a top wall, a bottom wall, and opposed side walls, the top wall having a pair of eyelets extending upwardly therefrom, the housing having a programmable memory chip disposed interiorly thereof, the front face having a display disposed therein, the display being in communication with the programmable memory chip, the display including a pair of programming buttons used to program a person's name, date of birth, medical condition, emergency contact and telephone number, and allergies; and
a circular line extending through the pair of eyelets of the housing to allow the housing to be worn about a neck of a user.

2. A medical information storage and display device for storing medical information of an individual for easy access in the event of an emergency comprising, in combination:
a housing having a front face, a back face, a top wall, a bottom wall, and opposed side walls, the housing having a programmable memory chip disposed interiorly thereof, the front face having a display disposed therein, the display being in communication with the programmable memory chip, the display including a pair of programming buttons used to program a person's name, date of birth, medical condition, emergency contact and telephone number, and allergies.

3. The medical information storage and display device as set forth in claim 2, and further including a circular line coupled with the housing to allow the housing to be worn about a neck of a user.
